(19) United States
(12) Patent Application Publication
(10) Pub. No.: US 2012/0096702 A1
(43) Pub. Date: Apr. 26, 2012

(54) AUTOMATED CONSTRUCTION SYSTEM

(76) Inventors: Alan Kingsley, Calgary (CA); Larry Bertelsen, Lloydminster (CA); Peter Miller, Lloydminster (CA); Richard Alan Roen, Centennial, CO (US)

(21) Appl. No.: 12/558,470

(22) Filed: Sep. 11, 2009

Related U.S. Application Data
(63) Continuation-in-part of application No. 11/855,320, filed on Sep. 14, 2007, now Pat. No. 8,127,418.
(60) Provisional application No. 61/096,039, filed on Sep. 11, 2008.

(51) Int. Cl. B23P 23/00; B23Q 7/00

(52) U.S. Cl. 29/561; 29/564.7; 29/35.5

(57) ABSTRACT

An automated construction system is described. Embodiments of the automated construction system comprise an inner work station having at least one working level, and an outer work station having at least one working level, with industrial robots disposed on the outer or inner work station. The outer work station typically surrounds the inner work station, with a shaft disposed between the two work stations. A lift or hoist is provided for raising and lowering a work piece in the shaft. Embodiments of the present invention further comprise a carousel adapted to forming work piece sections from metal plate.

The present application is a continuation in part (CIP) of U.S. patent application Ser. No. 11/855,320, with which it has common inventors. In addition, the present application incorporates by reference and claims priority to U.S. provisional patent application No. 61/096,039, with which it has common inventors.

### FIELD OF THE INVENTION

The present invention relates to an automated system for constructing a relatively tall structure by lowering all or part of the structure below ground level rather than using scaffolding to support work and equipment relatively high above ground level. Stable ground level work stations facilitate automation using robots for assembly.

### BACKGROUND

Constructing relatively tall structures typically involves working at substantial heights above ground. Examples of relatively tall structures include vessels such as, but not limited to, oil storage tanks and oil production tanks. Assembly of scaffolding both inside and outside a storage tank during construction or maintenance is thus typically required to support workers and equipment. Workers ascending, descending, and working at elevation are at increased risk of injury from falling, and repeatedly ascending and descending scaffolding in order to get to and from work takes valuable time and energy.

Lifting equipment onto scaffolding is also time and energy consuming. Construction of large tanks may require multiple cranes or other lifts for raising equipment and supplies onto scaffolding, in addition to larger cranes or lifts used to raise upper level tank components into place for tank assembly. Tools and equipment installed on or supported by scaffolding may have size limitations imposed due to space or weight limitations of the scaffolding.

In addition, precise placement of tools and equipment used in tank assembly may be limited by imprecision in scaffolding positioning and scaffolding positional instability. This imprecision may be particularly problematic for automated processes such as robotic welding, cutting, or testing, where positional parameters must be highly precise.

### BRIEF DESCRIPTION OF THE DRAWINGS

These and other features of the invention will become more apparent from the following description in which reference is made to the appended drawings. The drawings are for illustration only and are not intended to in any way limit the scope of the invention to the particular embodiment or embodiments shown, wherein:

FIG. 1 is a side elevation view, in section, of an automated construction system according to one embodiment of the present invention.

FIG. 2 is a top plan view of an automated construction system according to one embodiment of the present invention.

FIG. 3 is a detailed side elevation view, in section, of inner and outer work stations, according to one embodiment of the present invention.

FIG. 4 is a side elevation view, in section, of an automated construction system according to one embodiment of the present invention.

FIG. 5 is a side elevation view, in section, of an automated construction system using metal plate, according to one embodiment of the present invention

FIG. 6 is a side elevation view, in section, of an automated construction system using metal plate, according to one embodiment of the present invention

FIG. 7 is a perspective view of an automated construction system according to one embodiment of the present invention.

FIG. 8A is a perspective view of an automated construction system according to one embodiment of the present invention.

FIG. 8B is a perspective view of an automated construction system according to one embodiment of the present invention.

FIG. 9 is a perspective view of an automated construction system according to one embodiment of the present invention.

FIG. 10 is a top plan view of an automated construction system according to one embodiment of the present invention.

FIG. 11 is a side elevation view in section of an automated construction system according to one embodiment of the present invention.

FIG. 12A is a top plan view of auxiliary shafts disposed about a main shaft, in an automated construction system according to one embodiment of the present invention.

FIG. 12B is a side elevation view of auxiliary shafts disposed about a main shaft, in an automated construction system according to one embodiment of the present invention.

FIG. 13 is a side elevation view in section of a component being installed within the work piece using a crane, in an automated construction system according to one embodiment of the present invention.

FIG. 14 is a side elevation view of a scraper scraping a work piece in an automated construction system according to one embodiment of the present invention.

FIG. 15 is a side elevation view of a cutter cutting a work piece in an automated construction system according to one embodiment of the present invention.

FIG. 16 is a side elevation view of a clamp fitting up two sections of a work piece in an automated construction system according to one embodiment of the present invention.

FIG. 17 is a side elevation view in section of an arm used to fit up two sections of the work piece in an automated construction system according to one embodiment of the present invention.

FIG. 18 is a side elevation view in section of a mold positioned in an automated construction system according to one embodiment of the present invention.

FIG. 19 is a side elevation view in section of an example of a shaft installation in an automated construction system according to one embodiment of the present invention.

FIG. 20 is a flow chart illustrating a method of using an automated construction system according to an embodiment of the present invention.

### DETAILED DESCRIPTION

Embodiments of the present invention comprise an automated construction system that includes an inner work station and an outer work station, with the outer work station typically surrounding the inner work station. The outer work station resides at about ground level, with a shaft extending downwardly from an area residing between the inner work station and the outer work station. Embodiments of the automated construction system further comprise a hoist adapted to raising and lowering a work piece in the shaft. Some embodiments comprise a rotating device adapted to rotate the work piece, and in some embodiments the hoist and rotating device are one and the same. Embodiments of the present invention further comprise a carousel adapted to forming work piece sections from metal plate. The work piece may be a relatively tall vessel or part thereof. An example of a relatively tall vessel includes, but is not limited to, an oil storage tank or an oil production tank. A completed 1000 bbl oil storage tank is typically about 32 feet tall. A relatively tall vessel is typically greater than twelve feet tall.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning “either or both.”

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct connection between the identified elements, components, or objects. Often the manner of the coupling will be related specifically to the manner in which the two coupled elements interact.

The term “approximately,” as used in this specification and appended claims, refers to plus or minus 10% of the value given.

The term “about,” as used in this specification and appended claims, refers to plus or minus 20% of the value given.

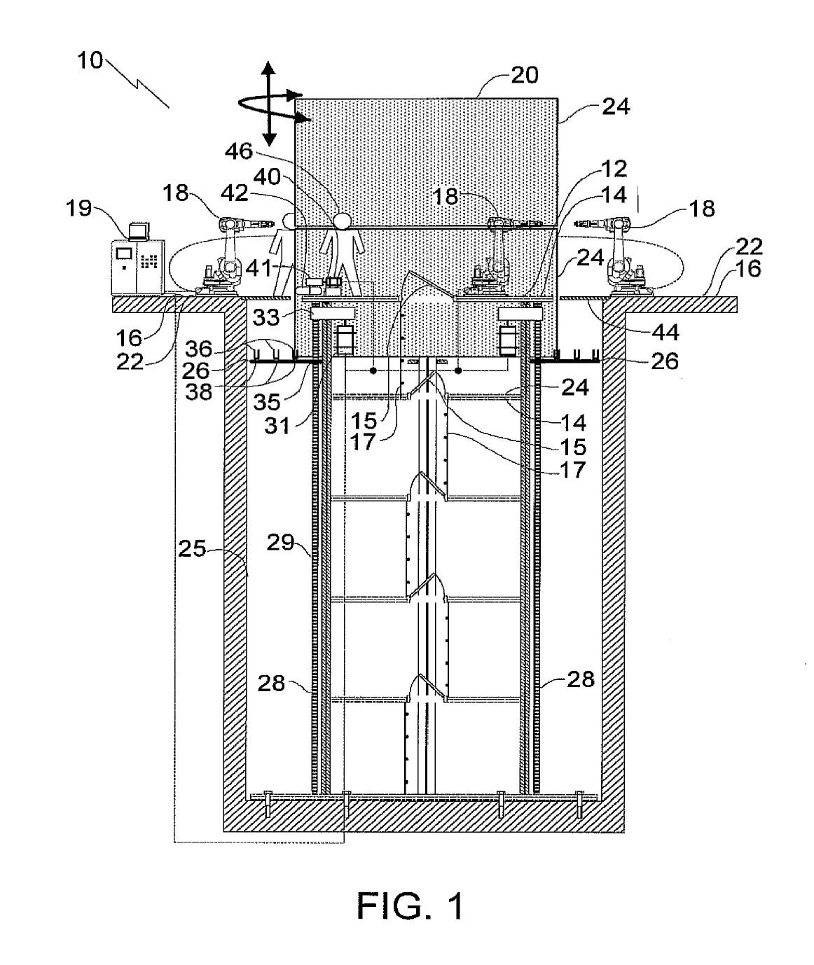

The terms “lift and rotate table,” “lifting rotating table,” and “LRT,” as used in this specification and appended claims, refer to a platform or support adapted to raise and lower with a work piece supported thereupon, and to permit the work piece to rotate while being supported by the platform or support, while the work piece is disposed in or partially in an automated construction system shaft. Thus a hoist in an automated construction system shown in FIG. 1 through FIG. 6, is an LRT. In some embodiments, the LRT rotates with the work piece.

The term “MIG-P,” as used in this specification and appended claims, refers to pulsed metal inert gas welds or welding.

The terms “manufacturing” and “fabrication,” are used interchangeably in this specification and appended claims, and refer to construction or assembly of a structure or component thereof.

The term “ground level,” as used in this specification and appended claims, refers to a level or altitude of a surface of the ground. Accordingly, an object or space that is below ground level resides at a level or altitude below a surface of the ground immediately proximate the object or space. An object or space that is above ground level resides at a level or altitude above a surface of the ground immediately proximate the object or space. An object or space that is considered at ground level, for purposes of this specification and appended claims, resides at a level or altitude about even with or slightly above or below a surface of the ground immediately proximate the object or space; an object that resides at ground level may rest on a surface of the ground.

The term “continuous sidewall structure,” as used in this specification and appended claims, refers to a structures having sidewalls, the bases of which form closed figures. For example, a cylindrical structure is a continuous sidewall structure because its base forms a circle, which is a closed curve. Other continuous sidewall structures include structures having sidewalls and whose bases form closed figures such as, but not limited to, circles, ovals, and other closed curves, and regular and irregular polygons. A structure may have an aperture in its sidewall and still be a continuous sidewall structure.

The term “ellipse,” as used in this specification and appended claims, refers to a plane curve such that the sums of the distances of each point in its periphery from two fixed points, the foci, are equal. It is a conic section formed by the intersection of a right circular cone by a plane that cuts the axis and the surface of the cone. Circles and ovals are special types of ellipses.

The term “closed curve shape,” or “closed figure shape,” as used in this specification and appended claims in reference to structures formed by metal plate, refers to a three dimensional analogue of a two dimensional closed curve or closed figure. For example, where metal plate is bent to form a closed curve shape that is a circle, the metal plate forms an open ended cylindrical structure. Where metal plate is bent to form a closed figure shape that is a rectangle, the metal plate forms an open ended right rectangular parallelepiped structure. In other words, the closed curve shape or closed figure shape is a three dimensional shape having a base that is a closed curve or closed figure, respectively.

### Structure and Relationship of Parts

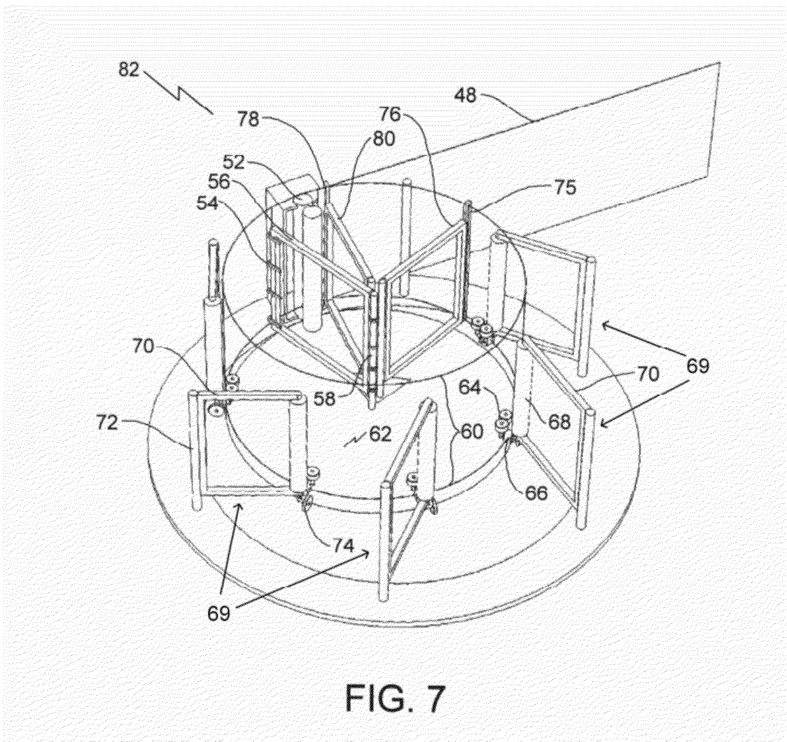

An embodiment of an automated construction system 10 is illustrated in FIG. 1 through FIG. 6. Variations are discussed with reference to FIG. 7 through FIG. 19. Referring to FIG. 1, an embodiment of automated construction system 10 includes an inner work station 12 and an outer work station 16. In this embodiment, the outer work station 16 surrounds the inner work station 12, and both the outer and inner work stations in are stationary. In other embodiments, the work stations may be mobile. Working levels 14 reside beneath the inner work station 12 and are accessed by hatches 15 and ladders 17. Inner work station 12 and outer work station 16 comprise robots 18 performing tasks to assemble the work piece 20, such as welding, cutting, grinding, or testing. Testing may be destructive or non-destructive. Robots 18 are six axis industrial robots, and are controlled by a controller 19. Some embodiments of automated construction systems comprise other types of robots. In some embodiments, human workers also perform tasks such as welding, cutting, grinding, or testing. Where human workers perform tasks directly, rather than using robots, the tasks are referred to as manual. It is understood that manual tasks may involve using power equipment such as power saws or power grinders.

While outer work station 16 is shown with only one outer working level 22, more than one outer working level may be included in some embodiments. Additional outer working levels allow multiple sections 24 of work piece 20 to be worked on at a time, or to access sections not currently being worked on. In addition, inner work station 12 may be removable to allow work to be done on other types of work pieces 20, where inner work station 12 would be inappropriate. Work piece 20 may be any structure with a continuous sidewall. The continuous sidewall may be cylindrical, oblong, oval, square, rectangular, or the like. A cylindrical work piece 20 is shown in the accompanying drawings, and discussed below as an example only. Those of ordinary skill in the art will be aware that modifications may be made to accommodate structures that are other than cylindrical.

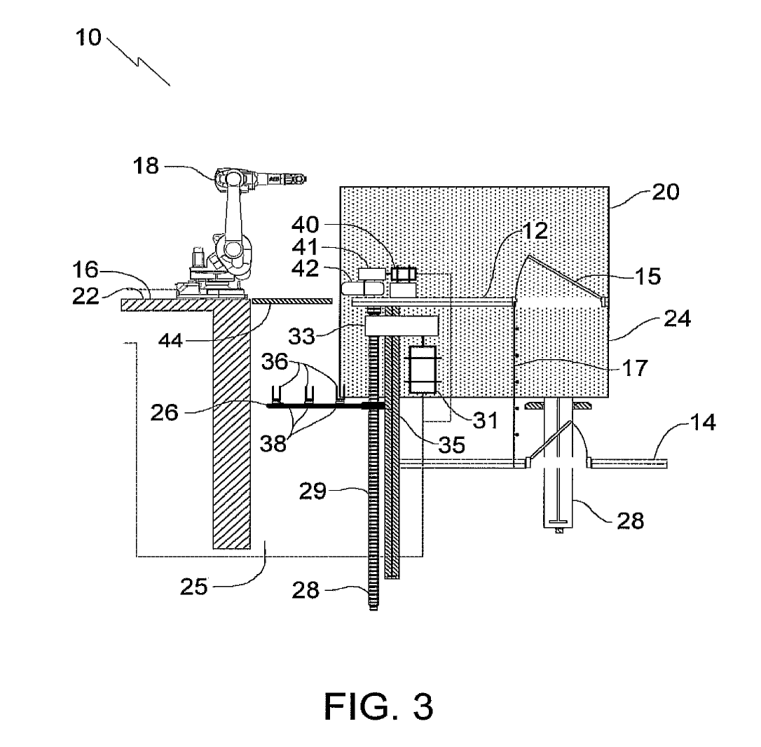

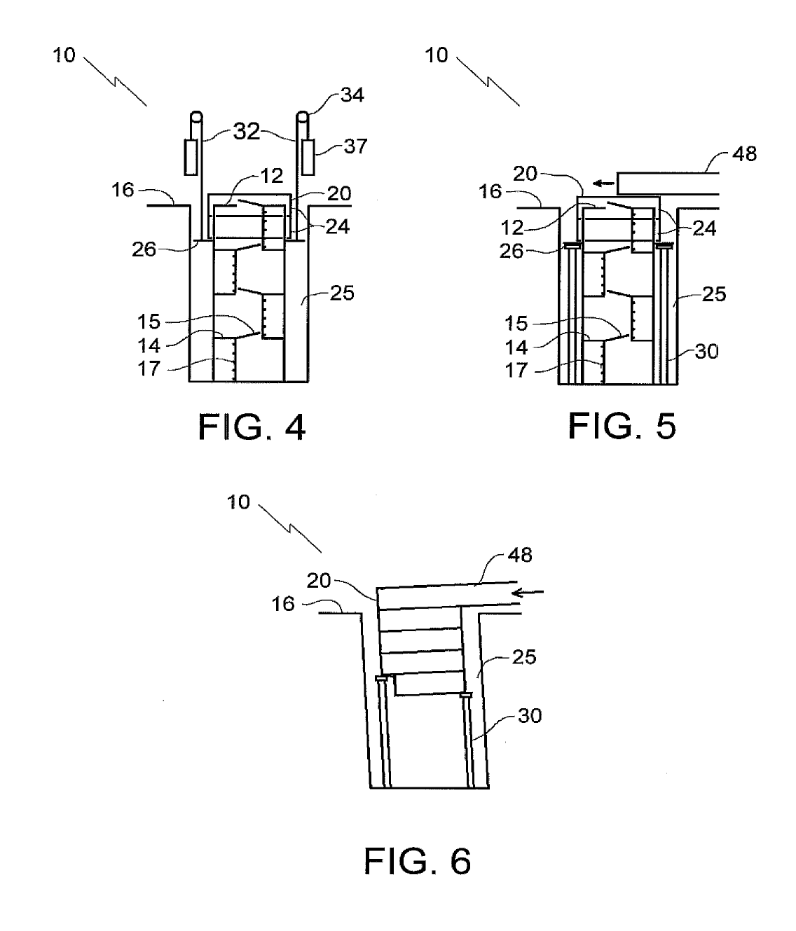

Referring to FIG. 3, the automated construction system 10 further comprises a shaft 25 extending downwardly from an area between inner work station 12 and outer work station 16, with a hoist 26 residing in the shaft. The shaft 25 is approximately vertical. The hoist is adapted to raising and lowering work piece 20 in shaft 25. While shaft 25 is annular and is thus adapted to fabrication of work piece 20, which is cylindrical, it is understood that other embodiments of shafts may have other shapes. Moreover, other components such as work stations 12 and 16 may require modification depending on shapes of work pieces to be fabricated. A further variation of shaft 25 is tilted from vertical as shown in FIG. 6. Shaft 25 may be dug into the ground or constructed above ground, as circumstances dictate. It may also be desirable to build shaft 25 into a hill. Hoist 26 is raised by ball screws 28 distributed about hoist 26 within shaft 25 so as to equally distribute the weight of work piece 20. Ball screw 28 includes a screw portion 29 driven by a motor 31 and transmission 33. Screw portion 29 rotates within a nut 35 attached to hoist 26. It will be recognized that other lifts may also be used, either from below or above. Examples include one or more hydraulic rams 30 that would apply force from below as shown in FIG. 5, a gears and sprockets arrangement (not shown), or hoist 26 may be raised from above, such as by using lifting chains or belts 32 distributed radially about hoist 26 as shown in FIG. 4. These lifting systems may be supplemented using pulleys 34, counterweights 37, or the like, as is known in the art. Hoist 24 is a hoist; other embodiments of hoists may attached directly to work piece 20 and may lift or support the work piece from above.

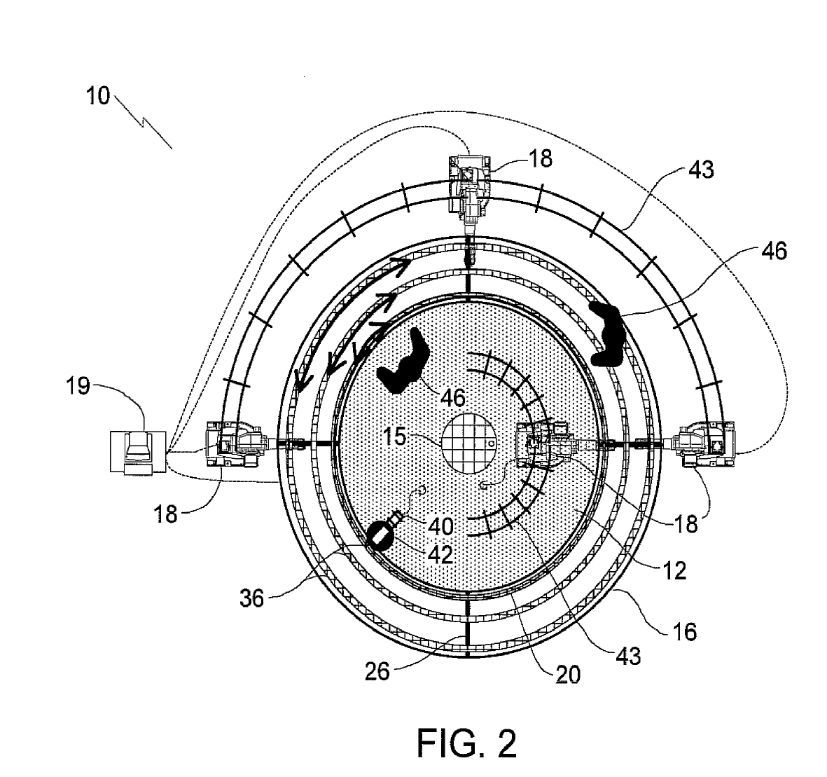

Referring to FIG. 2, as work piece 20 is raised on hoist 26, it may also be rotated to improve access to the entire work piece 20. Rotation and vertical movement of work piece 20 are coordinated by controller 19, which also controls robots 18, such that the entire system may be automated. Hoist 26 includes various work piece holders 36, which correspond to various sizes of work pieces 20. Referring to FIG. 3, the work piece holders 36 are mounted on bearings 38. Work piece 20 may be rotated by a motorized drive assembly, which comprises a motor 40, transmission 41, and driving wheel 42. The driving a wheel 42 engages the sides of work piece 20 to cause it to rotate.

While bearings have been illustrated as a rolling mechanism, there are many possible means for rotating work piece 20, such as bushings, rollers, or the like. In some embodiments, work piece 20 may be made rotatable in other ways. For example, by providing bearings in hoist 26 itself between two overlapping horizontal sections, or between two abutting horizontal sections. Referring to FIG. 2, in addition to rotating work piece 20, robots 18 may be mounted on servo tracks 43 to allow them to move about work piece 20 as well.

As mentioned above, automated construction system 10 is designed to accommodate different sizes and shapes of work pieces 20. Referring to FIG. 1, this is done by providing work piece holders 36 at different distances along hoist 26. In addition, an adjustable floor 44 is provided on outer work station 16 to provide access to work piece 20, and ensure the safety of workers 46. Adjustable floor 44 may be in the form of removable rings of various sizes, depending on the application.

Work piece 20 may be fabricated using preformed sections 24, where the vertical seam has been previously welded. Referring to FIG. 5, it may also be fabricated using metal plate 48, the metal plate typically, but not necessarily, comprising mild steel and having a thickness that falls in a range of about 3/16 inch to about ¼ inch. For the purposes of this specification and appended claims, metal plate includes coiled metal plate. Metal plate is sometimes referred to as plate metal. Metal plate 48 may be fed horizontally onto work piece 20 for each section, or preformed immediately prior to being placed on work piece 20. A vertical seam (if required) may also be welded by robots 18 or workers 46.

In some embodiments, metal plate may be fed continuously at a feed angle that is greater than 90°, the feed angle being an angle at which the metal plate intersects an axis of cylinder of a nascent work piece. A feed angle greater than 90° could abrogate a need for vertical seams, the metal plate forming a continuous spiral.

### Variations of Automated Construction Systems

In addition to embodiments described above, other variations may also be practiced. As illustrated in FIG. 7, some embodiments of the automated construction system comprise a first carousel 82. The first carousel 82 is adapted to form metal plate 48 into a section 24, the section 24 being cylindrical as illustrated in FIGS. 1-6. Metal plate 48 may be cut to a desired length necessary to form the section, or it may be cut as it is fed onto first carousel 82 if coiled sheet is used. The first carousel comprises feed rollers 52, clamps 56, and a center post 58. A leading edge of metal plate 48 is fed into feed rollers 52, and gripped by clamps 54 mounted on a rotating arm 56. As metal plate 48 moves through the feed rollers 52, rotating arm 56 rotates about a center post 58 and guides metal plate 48 to form a cylinder whose upper and lower edges form substantially identical circles represented by lines 60. It has been found that the desired shape is easier to obtain if arm 56 pulls at the same time that the metal plate 48 is pushed by feed rollers 52.

The first carousel further comprises a plurality of radial forming assemblies 69 oriented in an array adapted to form or maintain metal plate 48 into a cylindrical shape having an axis of cylinder disposed approximately at the center post 58. Each of the plurality of radial forming assemblies 69 is about a same distance from the center post 58 as others of the plurality of radial forming assemblies. The radial forming assemblies 69 comprise guide rollers, indicated generally by 62, which are positioned about center post 58, and assist in forming or maintaining a generally cylindrical shape as the section is formed from the metal plate 48. Guide rollers 62 include inner rollers 64 for guiding a nascent section inside surface, bottom rollers 66 to support metal plate 48 along a bottom edge, and a vertical roller 68 to guide the nascent section outside surface. The radial forming assemblies 69 further comprise pivoting arms 70, on which the guide rollers 62 are mounted. The pivoting arms 70 are adapted to move outwardly away from a center of the first carousel 82 to form a section having a larger diameter. Conversely, the pivoting arms 70 are adapted to move inwardly toward the center of the first carousel 82 to form a section having a smaller diameter.

The pivoting arms 70 are coupled to a support post 72 and a roller 74. The pivoting arms 70 are biased inwardly by a spring, such that vertical roller 68 applies a force on the metal plate 48 along the nascent section outside surface to help form or maintain a curved shape, while still allowing arms 70 to move outwardly if sufficient force is applied. The nascent section outside surface is an outside surface of metal plate 48 that is formed into a cylindrical structure or other continuous sidewall structure, or is being formed into a cylindrical structure or other continuous sidewall structure.

Once metal plate 48 has been sufficiently played out by feed rollers 52, the leading edge of metal plate 48 is transferred from clamps 54 on rotating arm 56 to a first welding clamp 75 mounted on a first clamp support arm 76, and the trailing edge of metal plate 48 is clamped to a second welding clamp 78 mounted on a second clamp support arm 80. Clamp support arms 76 and 80 are then brought together, and a vertical weld is applied to join the leading and trailing edges of metal plate 48 to form metal plate 48 into a cylindrical section 24 that may then be moved using a crane to be attached to work piece 20, as shown in FIG. 1. In other embodiments, the trailing edge may be clamped to the additional arm while the leading edge remains clamped to rotating arm 56. Other designs may also be used to properly clamp and position the trailing and leading edge of metal plate 48 to allow it to be welded together, one of which is discussed below.

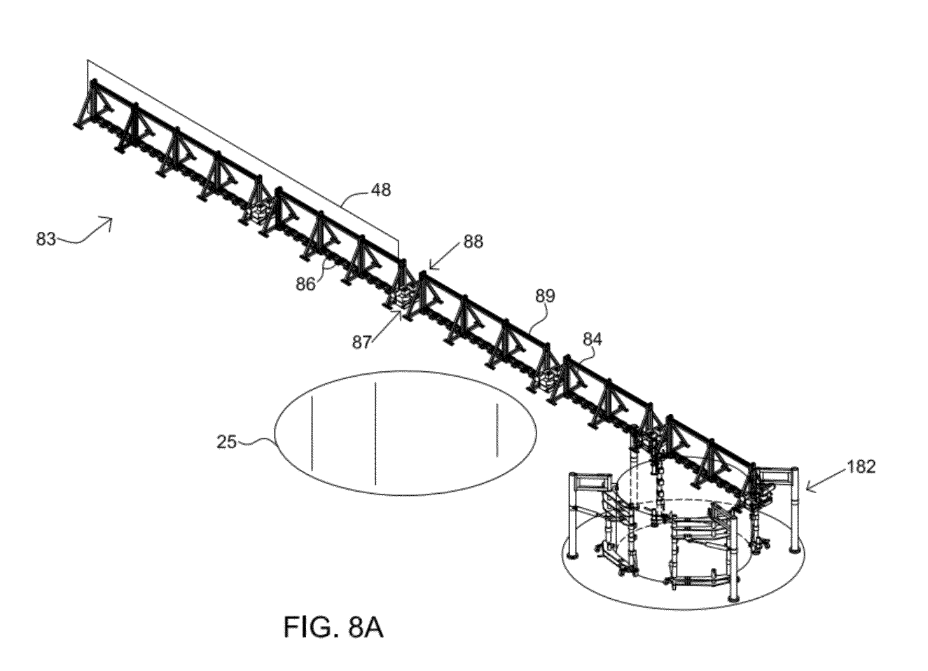

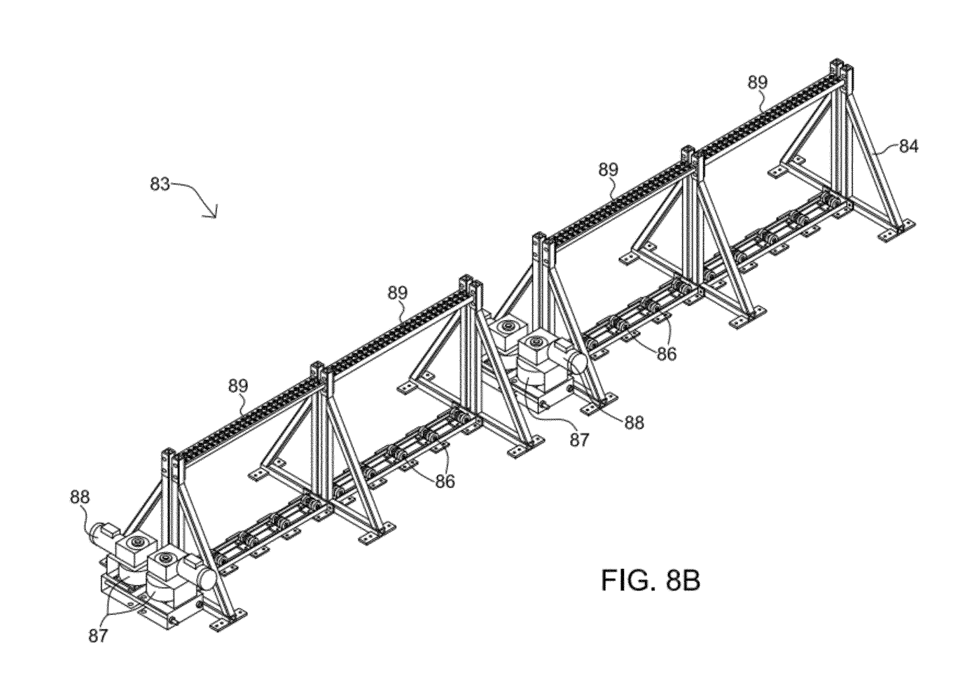

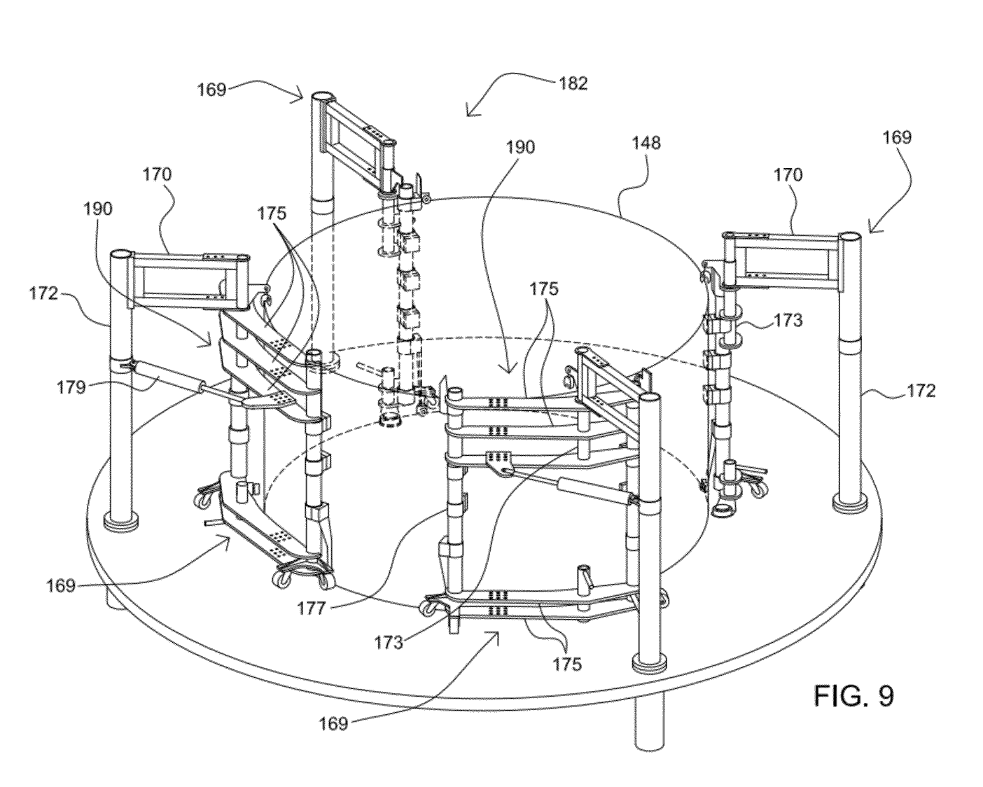

A feed fence 83 is illustrated in FIGS. 8A and 8B, which show an example of how metal plate 48 may be guided onto a second carousel 182. The feed fence 83 comprises upstanding supports 84, which in this embodiment have an “A” frame construction for strength. The feed fence further comprises support rollers 86 positioned between supports 84. The metal plate 48 rides on the support rollers 86 and is disposed between guide rails 89, the guide rails 89 holding the metal plate on edge, riding on the support rollers. The metal plate 48 is pushed along the feed fence 83 by drive wheels 87 that are powered by a motor 88. Variations or other means of guiding metal plate onto a carousel will be apparent to those skilled in the art. While arms are not shown in second carousel 182 in FIGS. 8A and 9, it is understood that they are present. The second carousel 182 and feed fence 83 are proximate a shaft 25.

Second carousel 182 is illustrated in greater detail in FIG. 9. The second carousel 182 comprises a plurality of radial forming assemblies 169 oriented in an array adapted to bend metal plate 148 to form a cylinder or other closed shape, such as a closed shape having an oval or tear drop radial cross section. The radial forming assemblies 169 comprise support posts 172 coupled to and supporting pivoting arms 170. The radial forming assemblies 169 further comprise carriage axles 173 that are coupled directly to both the pivoting arms 170 and to carriages 190, thereby serving to couple the pivoting arms to the carriages 190. The carriages 190 comprise carriage rollers 177 coupled to horizontal members 175. Actuator arms 179 are coupled to both the support posts 172 and to carriages 190. The actuator arms 179 of this embodiment are hydraulically powered and apply pushing or pulling force on the carriages 190 to cause the carriages 190 to rotate about the carriage axles 173. As is apparent to a person of ordinary skill in the art, the pushing force is created by a lengthening action of the actuator arm 179, and the pulling force is created by a shortening action of the actuator arm 179.

Where the actuator arm pushes the carriage 190 so that the carriage rollers 177 move inwardly toward a center of the carousel 182, the carriage rollers are positioned to bend or guide metal plate 148 into a curve having a shorter radius. Conversely, where the carriage rollers move outwardly away from a center of the carousel 182, the carriage rollers 173 are positioned to bend or guide metal plate 148 into a curve having a longer radius. Accordingly, the second carousel 182 is adapted to form metal plate into closed loops of various sizes, including cylindrically shaped sections having various diameters. In order to bend or guide metal plate along a curve, carriage rollers 177 apply a force on the metal plate 148 along a nascent section outside surface to help form or maintain a generally cylindrical shape. The force applied by the carriage rollers 177 is generated by the action of the actuator arms pushing against the support post 172 and the carriages 190.

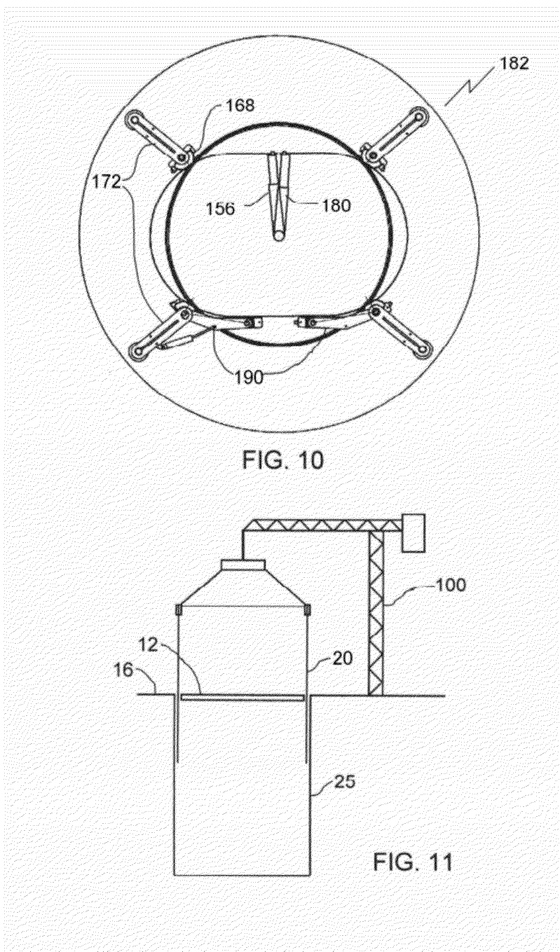

Referring to FIG. 10, carriages 190 are pivoted while arms 156 and 180 are retracted, such that metal plate 148 is bent into an oval shape with flat sides. It has been found that a “teardrop” shape for the section being formed can be avoided if the ends being welded are substantially aligned in a plane. It has also been found that this shape is easier to obtain if both sides of the course are pulled in at the same time. This causes portions of section 24 to slide across inner and outer work stations 12 and 16. It may be desirable to provide sliding surfaces or rollers to properly support section 24 or protect work stations 12 and 16. Carousel 182 may be positioned directly above hoist 26, or it may be positioned elsewhere, in which case sections that are formed would be transported to hoist 26. Other options to avoiding a teardrop shape include the application of heat, or using other positioning techniques, such as hydraulic rams. Furthermore, combinations of these techniques may negate the requirement that the ends be in a plane. Techniques to fit up sections that are not proper circles are discussed below.

Referring to FIG. 2, it is understood that track 43 may extend a part or all the way around hoist 26. Track 43 may be positioned on a table top hoist built into the floor of the shop. The table top hoist may be designed to accept extra sections on outer work station 16 to decrease the diameter of shaft 25, or to allow track 43, tooling or manipulators to be more easily installed. Various types of manipulators or tooling may be mounted to track 43, directly to the table top hoist at either the inner work station 12 or the outer work station 16. These include welding, grinding, wire or buffing wheels, treatment applicators such as insulation or other coatings, blasting tools such as sand pellet, brush, sponge, cutting tools, etc. It will also be understood that tooling may be positioned at inner work station 12 as well Other tooling an manipulators may be provided to allow a covering or cladding, such as an iron cladding, to be applied to the outer surface of the vessel.

As illustrated in FIG. 11, the hoist is an overhead crane 100, which is adapted to raise, lower, or rotate the work piece 20 in shaft 25.

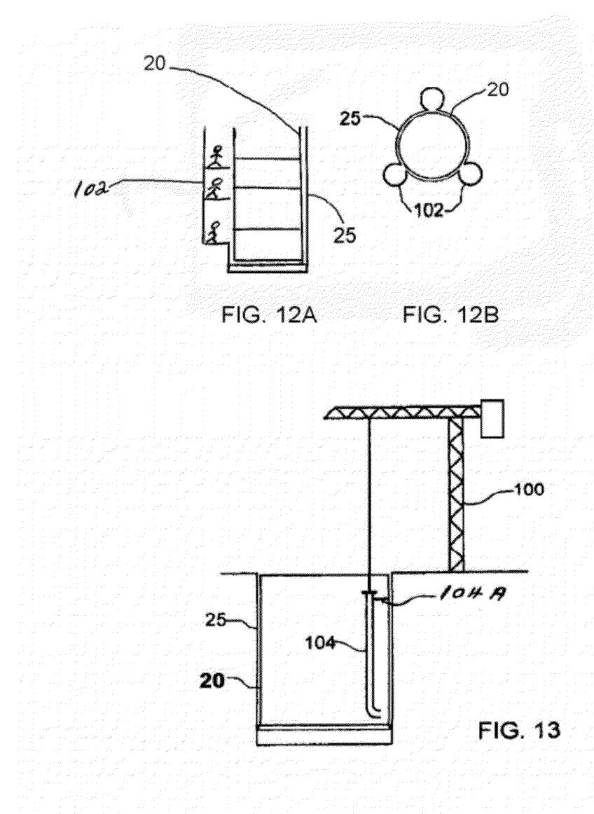

As illustrated in FIGS. 12A and 12B, secondary shafts 102 may reside about shaft 25, thereby providing access to lower portions of the work piece. In FIGS. 12A and 12B, the work piece is a used oil tank that has been removed from service for retrofitting or rehabilitation. The oil tank in illustrated in FIG. 12 is an oil storage tank. In some embodiments, the oil tank is an oil production tank.

Referring to FIG. 13, embodiments of the automated construction system 10 may be used to install components inside of work piece 20. For example, where work piece 20 is a production tank for the oil and gas industry, automated construction system 10 may be used to install riser pipes 104. Riser pipe 104 may lowered by a crane 100 into work piece 20 as shown or hung from inner work station 12 (not shown), and attached to the inside of work piece 20 at the desired orientation and elevation prior to lifting work piece 20 out of shaft 25. Disposition of part of the work piece below ground level substantially reduces height of crane 100 required for lowering riser pipe 104 into the work piece 20. Riser pipe 104 is held partially in place by brace 104A

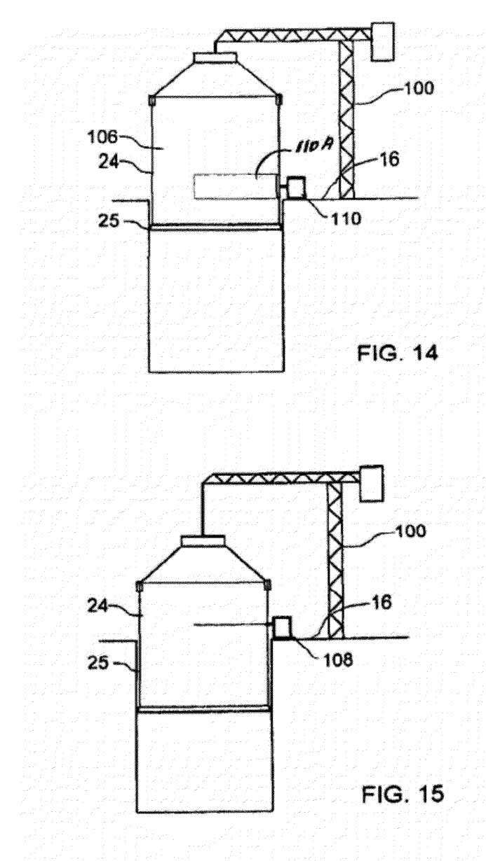

The automated construction system may also be used in situations other than tank fabrication. For example, existing tanks may be modified, repaired or retrofitted using similar design. In this situation, work piece 20 would be an existing vessel. For example, damaged sections to an existing vessel such as a used oil storage tank may be replaced including floors, roofs, or intermediate sections or sections may be removed or added to change the size of work piece 20. Other operations may also be performed, such as stripping insulation, in addition to welding and grinding operations. In one example, referring to FIG. 14, insulation 104 is stripped by a stripping knife 106 at a work station 16 as work piece 20 is rotated. Work piece 20 in FIG. 14 is a used oil storage tank that has been taken out of service for retrofitting or rehabilitation.

Once the insulation has been stripped, referring to FIG. 15, the top of work piece 20 is connected to a crane 100, and rotated while a cutting tool 108 such as a chop saw, cutting wheel or cutting torch cuts the wall of work piece 20. Additional cuts are made if necessary by either using additional cranes, or setting the top portion down and using the same crane. New sections are added using methods described above, following which the top is replaced using crane 100. Work piece 20 may also be insulated or reinsulated by providing an insulation applicator 110 such as a sprayer at inner work station 12. In a stripped section 110A, insulation has been stripped from the work piece.

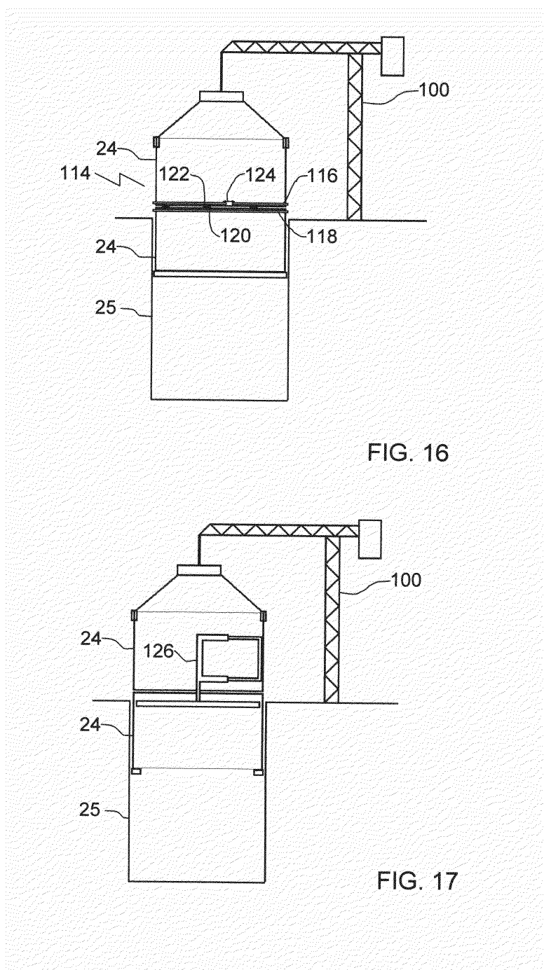

Referring to FIGS. 16 and 17, two options for aiding with the fitting up of two courses or sections 24 is shown. In this example, sections 24 may be formed using a variety of techniques known in the art, such as course loopers or cradles, or those discussed herein, such as a carousel, and are preferably useful when the two sections are not identical, such as if a teardrop is formed. In the event that the edges of sections 24 do not match up, it may be necessary to manipulate sections 24 to allow them to be welded. Referring to FIG. 16, a clamp 114 may be used. Clamp 114 is made up of two compression rings 116 and 118 separated by supports 120 that may have spacers 122 pivotally attached to supports 120. Lower compression ring 118 is attached to the top of the lower section 24, and spacers 122 are positioned over the top edge. The upper section 24 is then positioned on top of the lower section 24, and the upper compression ring 116 is attached to the bottom. One or both compression rings 116 and 118 have a tightening mechanism 124, such as a continuous screw to apply pressure to the associated section 24 to get it to the desired shape. This allows sections 24 to be properly fit up with the appropriate gap provided by spacers 122 that are removed when no longer needed, and the appropriate alignment provided by clamp 114. Rollers (not shown) may be included with compression rings 116 and 118 to make this easier. Referring to FIG. 17, in situations where a point on section 24 needs to be forced outward, an articulating arm 126 may be positioned on inner work station 12 and used to apply pressure to obtain the desired alignment when fitting up the sections 24. Arm 126 is preferably telescopic. Arm 126 may be particularly useful, for example, when section 24 forms an “inward teardrop” shape at the weld.

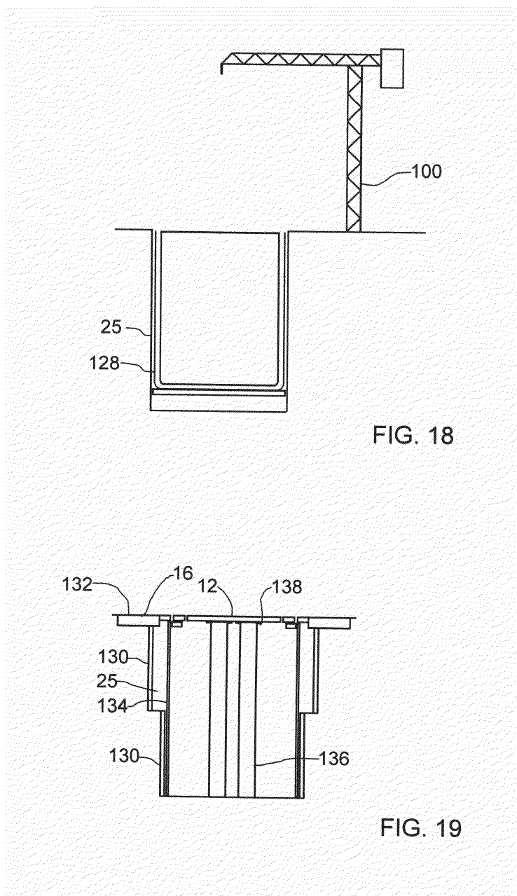

It is anticipated that shaft 25 may be used to form other types of vessels. For example, referring to FIG. 18 certain vessels may be fabricated by providing a mold 128, possibly formed using techniques described herein, lowered into shaft 25, and used to form vessels of materials that require a mould, such as a plastic vessel.

Referring to FIG. 19, an example of an installation is shown. As can be seen, shaft 25 is stepped. This is to provide structural strength during and after construction, and may not be necessary in all situations. Insert cylinders 130 are used to form the inner surface of shaft 25, and may be back filled with concrete. Outer work station 16 is preferably a table top hoist 132 formed into a floor of a factory, and supports a helical worm gear 134 that causes hoist 26 to move up and down. Rotating means for hoist 26 are not shown, but are preferably included, as discussed previously. Inner work station 12 is mounted on piles 136 that extend from the bottom of shaft 25. Piles 136 preferably have flanges 138 at the top that allow inner work station 12 to be removed, and replaced with a different size when a different diameter of vessel is being constructed. Variations from this example will be apparent to those skilled in the art given the benefit of this disclosure.

### a First Method of Using an Automated Construction System

A first method of fabricating a cylindrical structure using the automated construction system described above with reference to FIG. 1 through FIG. 6, will now be discussed. The cylindrical structure being fabricated in FIG. 1 through FIG. 6 is an oil storage tank having a volume of approximately 1000 bbl. Referring to FIG. 1, the first method starts by placing a section 24 of work piece 20 on hoist 26 in the appropriate work piece holder 36. Work piece 20 is then lowered using ball screws 28 to an appropriate height, and another section 24 of work piece 20 is positioned on top. Robots 18 or workers 46 positioned at inner work stations 12 and outer work stations 16 proceed to attach the two sections 24, based on the commands from controller 19 in the case of robots 18. As work proceeds, work piece 20 may be rotated by a motorized drive assembly. The motorized drive assembly comprises a motor 40, transmission 41, and driving wheel 42. The driving wheel engages the work piece 20 in order to rotate the work piece and hoist 26. In some embodiments, the motorized drive assembly rotates the work piece by engaging the hoist. Referring to FIG. 2, robots 18 may move along servo tracks 43. Referring to FIG. 1, work piece 20 is lowered again for the next section 24 to be attached, with the rotation and vertical movement of work piece 20 being coordinated with robots 18 by controller 19. The first method continues until all sections 24 of work piece 20 have been attached. The final section to be attached may be an end piece. Access to lower sections 24 of work piece 20 is provided via hatches 15 and ladders 17 for inspection, testing, or further work. Once all sections have been satisfactorily attached, work piece 24 is removed by raising hoist 26 and using, for example, a crane (not shown) to remove work piece 24. Work piece 20 may then be installed on its other end, which could not be positioned previously due to the presence of inner work station 12. Referring to FIG. 6, if coil metal plate 48 is used and run on at an angle, work piece 20 may be continuously lowered as the seam is sealed by welding, rather than in the stepwise fashion described above.

### a Second Method of Using an Automated Construction System

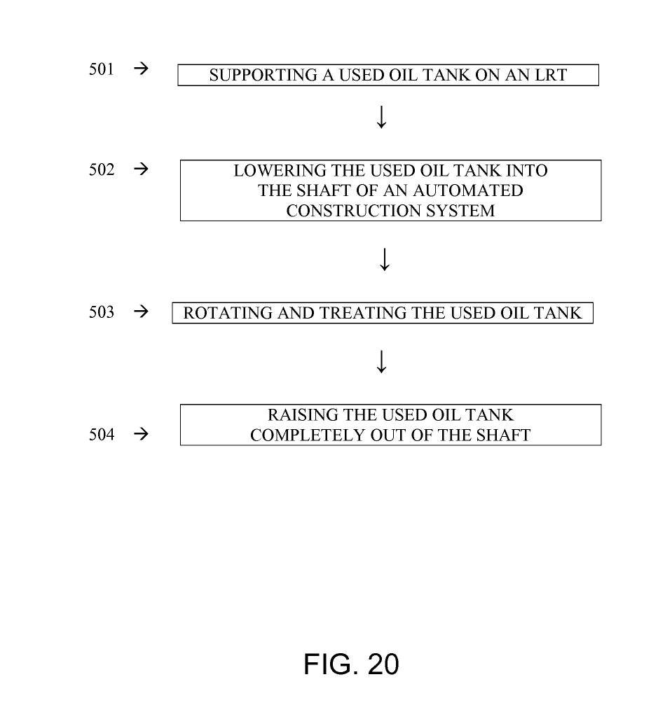

A second method of using an automated construction system is illustrated by a flow chart in FIG. 20. The first operation 501 comprises supporting a used oil tank on an LRT. The used oil tank is an oil storage tank or an oil production tank that has been removed from service for retrofitting or rehabilitation. The used oil tank is about 14 feet in diameter and about 32 feet tall, including a conical roof. The used oil tank has a capacity of approximately 1000 bbl. The LRT is a component of an embodiment of an automated construction system. The automated construction system comprising an outer work station, the hoist, and a shaft. The shaft is a cylindrical cavity in the ground approximately 25 feet deep, having a diameter of at least 17 feet. In some embodiments the shaft comprises a stepped cavity including cylindrical shapes of varied diameters (see FIG. 19). The outer work station resides at ground level immediately proximate to and surrounding the shaft.

The second operation 502 comprises lowering the LRT on which the used oil tank resides, into the shaft, until a lower part of the used oil tank resides below ground level in the shaft, the lower part having a height of about 24 feet. An upper part of the used oil tank resides above ground level and has a height of about eight feet. In this position, the upper part is readily accessible to workers and equipment disposed on the outer work station, without requiring scaffolding. As illustrated in FIG. 12, variations of automated construction systems include secondary shafts 102 that reside adjacent to and are continuous with and parallel to the shaft 25. The secondary shafts 25 provide access to the lower part of the work piece 20 (a used oil tank in this case) that resides below ground level.

The third operation 503 comprises rotating the used oil tank on the LRT and treating the oil tank while the lower part of the oil tank resides in the shaft. Treatment includes, but is not limited to, welding, cutting, removing corrosion, removing insulation, surface preparation, application of paint or other coating, application of anti-corrosive material, installation of insulation, and retrofitting the used oil tank. Treating the used oil tank may involve treating a tank exterior or tank interior.

The fourth operation 504 comprises elevating the oil tank completely out of the shaft. If retrofitting or rehabilitation is complete, the oil tank may be returned to service.

### a Third Method of Using an Automated Construction System

Some methods of using an automated construction system comprise fabrication of a vessel, the vessel being a cylindrical oil storage tank. The automated construction system comprises six-axis industrial robots interfaced to pulsed metal inert gas (MIG-P) welding sources, and to PLASMA cutting sources, manual welders, laborers, and a lift and rotate table (LRT). The vessel is a 1000 bbl oil storage tank. Fabrication is interactively performed with the help of the LRT, robots, and manual labor. Use of the LRT allows most operations to be performed safely at ground level or below. This feature significantly reduces risk of industrial accidents inherent in traditional assembly methods such as using scaffolding to support workers and equipment high above ground. The vessel fabrication using the LRT also results in faster manufacturing of oil storage tanks compared to existing manufacturing methods.

The vessel typically comprises four stacked sections, each section including a cylindrical outer wall, and all sections having a diameter approximately the same. The vessel typically further comprises a floor, a roof, and accessories mounted to or through its outer wall and roof. The vessel may also comprise paint, external insulation, or an internal coating such as epoxy.

The LRT is prepared for the assembly process by elevating the LRT to ground level and installing appropriate safety floor sections to avoid injuries to personnel caused by falling between inner and outer work stations and into a shaft that extends below the work stations. An appropriate build sequence (Programmable Logic Controller (PLC) program and robot programs), as well as the vessel dimensional data, are loaded to the system's controller. The vessel dimensional data may be loaded into the system controller from a conventional CAD file.

Vessel fabrication methods using embodiments of the automated construction system enable industrial automation to be combined with manual operations in construction of continuous sidewall structures such as oil storage tanks. The LRT works together with industrial robots and manual welders to facilitate welds and cuts throughout vessel fabrication. The system controller prompts and guides workers throughout the vessel build sequence. The system controller touch screen advises workers of all manual tasks to be performed on the vessel, displays any pertinent data required for them to execute their tasks, as well as requests the launch of automated assembly sequences. Vessel fabrication methods using embodiments of the automated construction system reduce chances of errors during vessel assembly, thus significantly increasing work quality as well as substantially decreasing cycle times and thus increasing manufacturing output capacity.

One embodiment of an automated construction system illustrated in FIG. 1 through FIG. 3, comprises three robots 18, one installed on an inner work station 12 and two of which are installed on an outer work station 16. The robots of this embodiment are six-axis industrial robots. The robots are equipped with interfaced MIG-P welding sources, etching devices, seem finders, and seam tracking devices. They may also be equipped with quality control systems such as inline radiography devices or vision inspection cameras. In addition, the robot 18 installed on the inner work station 12 is equipped with an interfaced PLASMA cutting source and tool changers, in order to perform through wall cutting activities. Through wall cutting capability is necessary to install vessel accessories the pass through the outer wall. Each robot is linked to its own robot controller, all robot controllers are networked to the system controller.

Embodiments of an automated construction system comprise remote control devices equipped with safety interlocking controls, interactive touch screens, and manual motion control of LRT functions. The remote control devices assist operators during manual tasks, display process information and vessel data, assist maintenance workers during their task, and simplify programming tasks.

Some embodiments of an automated construction system comprise two distinct zones identified and guarded appropriately for worker safety. A first zone is strictly forbidden to all operators' helpers, and welders; it is an area in which the industrial robots perform their work. The first zone may be accessed only by authorized personnel such as maintenance workers, programmers, and engineers under stringent safety procedures. A second zone is an area utilized for manual operations pertinent to assembly of a vessel. This second zone is a controlled safety zone; workers are permitted access only under certain circumstances such as when the robots are inactive or when operation of the robots does not create substantial danger or risk of injury to the worker. The second zone is controlled with approved safety devices such as, but not limited to, pressure sensitive safety mats, light curtains, multiple light beams, and/or proximity laser scanners. Access to the second zone is monitored by safety devices and in conjunction with the system controller.

INSTALLATION OF A FIRST SECTION—A first operation of vessel fabrication comprises forming a first cylindrical section. The first cylindrical section is formed using a carousel as illustrated in FIG. 7 and FIG. 9. In doing so, a rectangular metal sheet of mild steel is formed horizontally to a circular shape along its length and locked into shape with fixtures and jigs to allow for welding a vertical seam, thus creating a cylindrical section.

Other vessel sections are formed in a substantially similar way as the first section. Once the first cylindrical section is formed, it is picked up by an overhead crane with an internal grip (or any other adapted handling device) to the top of the section and positioned onto a work piece holders disposed on an LRT. At this time, an operator informs the LRT controller via one of the remote control devices that the first section is in place, which actuates a series of internal positioning roller arms. The internal roller arms apply force outwardly to the internal wall of two superposed sections. These positioning devices are comprised of two sets of individually pneumatic actuated cylinders with rollers able to apply horizontal force to the inner wall of two vessel sections mounted one on top of each other without restricting the sections from being rotated by the LRT for the welding of their joint seam. They are automatically controlled via the LRT's system controller, and are used to maintain cylindrical tolerance of the sections, as well as to maintain any required welding gap tolerances between two superposed sections.

Once this operation is done, the internal gripper releases and the overhead crane then removes the internal gripper. At this point in time, an operator informs the LRT to initiate the assembly process from the LRT controller's interactive touch screen monitor. This action launches the LRT's initialization routine; the LRT rotates the vessel section while sensing with a laser scanner until it detects the section's vertical seam. Once the vertical seam is detected, the LRT controller establishes a positional reference relating to the vessel's CAD date.

The first section is then rotated to a position from which the internal robot can cut out the vessel's doorway opening, and then proceeds to cutting it out with its PLASMA cutting equipment. Upon completion of the cut, the vessel is rotated by the LRT to the manual assembly area and then comes to a stop.

Manual task information is then displayed to the LRT's controller touch screen regarding the installation and welding of the doorway's frame. The information displayed refers to the specifications of the vessel's doorway, it provides the welder and operator specific information referring to orientation, shape and dimensions pertinent to proper installation of the part, if required, any additional tasks to be performed such as repads to be welded to the perimeter of the cutout shape, or mechanical assembly information such as torque settings, bolt sizing, etc., can also be displayed. The doorframe is welded on to the vessel's exterior wall around the doorway cut out, and the LRT controller is notified once the task is completed. The cutting out and installation of the doorway allows workers to access the interior of the vessel when all four sections of the vessel's wall and the roof have been installed, thus allowing work to be performed from the inside of the vessel on the LRTs centre column.

INSTALLATION OF A SECOND SECTION—Upon completion of the previous task, the operator informs the LRT's controller via its touch screen, and initiates the following automated sequence. During this sequence, the vessel section is rotated and lowered by the LRT to a preprogrammed level and orientation for manual assistance during the stacking of the second section onto the first one. Once in the correct position, the LRT stops and advises via its touch screen display, the details of the next operational tasks. Then the second section of the vessel, previously formed to a cylindrical shape and vertically welded, is moved on top of the first section by the overhead crane with an internal gripper holding it from the top. This section is manually guided into position on top of the first section, aligned, and on a command to the LRT controller via one of its data input devices, the upper internal roller arms are actuated, thus positively positioning the second section in relation to the first. Thereafter, the crane is detached from the second section's internal gripper, which remains attached to the top of this section to maintain its cylindrical shape. Subsequently, an operator notifies the LRT's controller via its touch screen that the task is completed. Thereafter, the LRT system controller initiates an automated sequence for the internal and external welding of the horizontal joint seam between the two sections. During this sequence, both sections are rotated together by the LRT, while simultaneously both external robots weld two horizontal passes to the joint seam and the internal robot welds a single pass to the same joint seam from the inside.

Upon completion of the seam welding, the LRT system comes to a rest and advises operators to remove the internal gripper still attached to the top section. Once this task finished and the LRT control system is advised, the LRT control system automatically retracts all roller arms, lowers the sections to appropriate manual working height, and rotates the section assembly to a specified 155 orientation for the installation of the next section. Once this sequence is completed, operators are notified via one of the LRT controller displays to proceed with the installation of the next section.

INSTALLATION OF THIRD AND FOURTH SECTIONS—The process repeats itself as described above for the third and fourth sections of the vessel.

INSTALLATION OF A STIFFENING RING—Once all four sections have been assembly on the LRT, using the overhead crane, a prefabricated and formed stiffening ring is installed to the outer side of the fourth section wall. It is secured in position by actuating the automated internal roller arms. The LRTs controller is then informed of the installation of the stiffening ring via its touch screen by an operator. As a result, the LRT's controller launches the welding sequence for the stiffening ring. The ring's top and side seams are simultaneously welded by the two robots during a continuous specific speed rotation of the vessel by the LRT.

Upon completion of this sequence, the LRT's controller stops the rotation of the vessel, displays the next manual task to be performed, and awaits further input from the operator before proceeding.

ROOF INSTALLATION—Before the next LRT operation can be executed, the vessel's roof is manually or automatically shaped, assembled, and welded together. All roof options are installed on the roof as well as roof lifting lugs for handling purposes. The roof is lifted by the overhead crane by its lifting lugs, then positioned on top of the vessel's cylindrical shell, aligned accordingly, and then released on to the vessel. The overhead crane is detached from the roof. Thereafter, the LRT's controller is notified via its touch screen that the roof is in position. Then an automatic sequence is launched, where the LRT starts rotating the assembly at a specific speed and the two external robots weld the seam joint between the roof and the vessel wall.

When this operation is completed, the LRTs rotation ceases and robots come to a rest position. In the next sequence the vessel wall and roof assembly are lowered to an acceptable level above ground, permitting workers to remove previously welded roof lifting lugs, roof lifting lugs may not be required if using an adapted roof lifting device.

Again, once this operation is completed, the LRT is advised via manual input to its touch screen. At this time, the vessel assembly is at its lowest elevation within the LRT; all subsequent operations occur as the LRT raises the vessel assembly to a point when it will be totally submerged at ground level with all accessories installed. Fourth section accessories

Following the operator acknowledging the completion of the last task, the LRT lifts the fourth section of the vessel to a predetermined height, starts rotating the assembly, while simultaneously the two external robots etch on the section's wall the exact locations of all externally mounted accessories, then LRT positions the section in an appropriate location for the manual the manual welding of these accessories. This sequence may require that operators advise the LRT controller upon completion and the LRT then rotates by a half turn to allow access for the installation of accessories previously not accessible form the controlled safety manual work zone.

During these operations, the LRT % controller touch screen informs the worker of locations and orientations for all fourth section accessories, such as vessel lifting lugs, hauling pads, ladder dips, ladder and cage sections, and gauge board clips and sections to be attached to the surface of the vessel wall.

Prior to proceeding to the next step of assembly, an automatic unlatching sling is attached to the vessel's lifting lugs allowing for the crane operator to easily attach his hook when the time comes to remove the vessel from the LRT. The previous operation is required as, because when the time comes to remove the vessel it will no longer be possible to lower the vessel on the LRT as all vessel accessories will be installed onto the vessel, and may be protruding beyond the vessel wall, thus restricting it from being lowered to install any lifting devices such as slings.

INSTALLATION OF THIRD SECTION ACCESSORIES—Once all of these accessories are installed onto the vessel, an input from the operator confirms completion of all fourth section accessory installations, the LRT proceeds by raising the vessel assembly to expose the third section at a specific height from ground, and then the robotic etch process is launched for all third section external accessories as previously described above.

Thereafter, the LRT controller displays via its screen the positions and orientations of the third level accessories to be mounted to the vessel welt. At this level, ladder clips, ladder sections and cages, gauge board clips and gauge board sections, are installed to the surface of the vessel wall.

INSTALLATION OF SECOND SECTION ACCESSORIES—On this section of the vessel surface accessories such as ladder clips, ladder and cage sections, gauge board sections and clips, and platforms are installed. Contrary to the other section, the second section requires shapes to be cut out of the vessel wall allowing for the installation of a loading spout, couplings, a burner throat flange, and burner supports.

Once the previous manual task completed the LRTs controller is informed via its touch screen, the LRT then raises the vessel assembly to an appropriate working level, rotation is initiated for the external robotic etching of surface accessories, the cutting of pass through accessory holes with the internal robot, then the LRT stops, and displays relative accessories information for this level's accessories, and awaits an input to continue. At this time, an operator notifies the LRT controller, the LRT lifts and rotates the vessel assembly until the doorway access to the inside of the vessel is exposed and accessible for workers to enter the inside of the vessel onto the LRTs centre column. Once the vessel is positioned by the LRT, welders and operators are notified via the LRT controller display screen. Thereupon, workers enter the vessel onto the LRTs centre column, take control of the LRT via its handheld control unit, and rotate, lift, and/or lower the vessel assembly to accommodate the installations of all pass through accessories and internally mounted surface accessories. Pass through accessory installations commence with the installation and weld of any repads as required by the vessel's specifications, installation and tacking of all pass through accessories from the outside of the vessel, and complete welding of all pass through accessories from the inside and outside of the vessel, installing and welding of the burner support system inside the vessel, as well as installing and securing the burner inside the vessel.

Once all accessories installations are completed on the second section, workers exit the vessel and the LRT controller is informed. Upon completion of this last task, all workers exit the vessel, and the LRTs controller is informed via its touch screen control. The vessel is then raised to an appropriate height for the installation of all first section accessories from the outside and inside of the vessel.

INSTALLATION OF FIRST SECTION ACCESSORIES—The sequence of assembly of the second section accessories is then repeated for all first section accessories. This section requires ladder dips, ladder and cage sections, gauge board sections and clips, hauling pads, and enviro-vault hinges, if required, to be installed and welded to the exterior wall of the vessel, as well as pass through accessories such as flanges, and couplings. Once these tasks are completed workers exit the vessel and inform the LRT of completion.

FLOOR INSTALLATION—At this point in the assembly process the vessel is ready to be moved onto the floor. The floor previously assembled may have an enviro-vault sitting on its surface, is located at ground level on the plant floor within the immediate proximity of the LRT. The overhead crane lifts the vessel assembly off of the LRT, positions and aligns the assembly onto the floor, the crane than release the vessel from its automatic unlatching lifting sling. Once the vessel assembly is sitting on its floor, if required, the enviro-vault is moved into its proper position within the vessel. From thereon, the horizontal seam between the vessel wall and its floor is internally and externally welded, as well as, again it required, the enviro-vault to the vessel's floor and internal wall.

INSULATING, PAINTING, AND COATING—At this time, the vessel is ready to be insulated and thereafter painted, which may require moving the vessel to an explosion proof chamber. Once in the chamber, the vessel is insulated, externally painted, and internally coated if required.

It will be apparent to one skilled in the art that modifications may be made to the illustrated embodiments without departing from scope of the Claims.

I claim:

1. An automated construction system comprising:
an outer work station, the outer work station residing at about ground level;
an inner work station, the inner work station residing at about ground level;
a shaft, the shaft extending downwardly below ground level from an area residing between the inner work station and the outer work station; and
a hoist, the hoist being adapted to raise or lower in the shaft.

2. The automated construction system of claim 1, wherein the shaft is annular and surrounds the inner work station.

3. The automated construction system of claim 2, further comprising a rotation device, the rotation device being adapted to rotate the work piece around the inner work station.

4. The automated construction system of claim 1, wherein at least one of the inner work station or the outer work station comprises a robot adapted to perform an operation selected from the group consisting of welding, cutting, grinding, or testing.

5. A method of using the automated construction system of claim 4 comprising:
placing a first section on the hoist, the first section comprising a first cylindrical wall;
lowering the first section into the shaft;
placing a second section immediately proximate the first section, the second section comprising a second cylindrical wall; and
welding the second cylindrical wall to the first cylindrical wall.

6. The method of claim 5, wherein the welding the second cylindrical wall to the first cylindrical wall comprises a welding operation performed by the robot.

7. The method of claim 5, further comprising rotating a work piece around the inner work station, the work piece comprising the first tank section and the second tank section.

8. The method of claim 6, further comprising rotating the first section and second section in unison.

9. The method of claim 8, wherein welding the second cylindrical wall to the first cylindrical wall occurs while the rotating the first section and the second section in unison.

10. The method of claim 7, further comprising manually welding the work piece.

11. A method of using the automated construction system of claim 1 comprising:
using the hoist to lower a used oil tank into the shaft, the used oil tank being selected from a group consisting of oil storage tanks and oil production tanks;
working on an inside of the oil tank from the inner work station.

12. The method of claim 11, wherein the automated construction system further comprises a secondary shaft, the secondary shaft being continuous with and substantially parallel to the first shaft.

13. An automated construction system comprising a carousel, the carousel including a plurality of radial forming assemblies, the radial forming assemblies comprising rollers and being oriented in an array adapted to bend metal plate to form a closed figure shape.

14. The automated construction system of claim 13, further comprising:
an outer work station, the outer work station residing at about ground level;
an inner work station, the inner work station residing at about ground level;
a shaft, the shaft (i) being annular, (ii) surrounding the inner work station, and (iii) extending downwardly below ground level from an area residing between the inner work station and the outer work station; and
a hoist, the hoist being adapted to raise or lower a work piece in the shaft.

15. The automated construction system of claim 14, further comprising a rotation device, the rotation device being adapted to rotate the work piece around the inner work station.

16. A method of using the automated construction system of claim 13 comprising:
feeding the metal plate into the array;
bending the metal plate by pushing against a metal plate surface with one or more of the rollers;
simultaneously pressing at least two of the plurality of radial forming assemblies against the metal plate surface; and
forming the metal plate into a closed figure shape.

17. The method of claim 16, wherein one or more of the plurality of radial forming assemblies further comprises two or more horizontal members, the two or more horizontal members being coupled to the roller.

18. The method of claim 17, wherein:
the one or more of the plurality of radial forming assemblies further comprises an actuator arm, the actuator arm being coupled to at least one of the two or more horizontal members, and further comprising applying force to the at least one of the two or more horizontal members by a lengthening action of the actuator arm.

19. The method of claim 16, wherein the carousel further comprises feed rollers, the feed rollers comprising two or more parallel rollers, at least two of the two or more parallel rollers having parallel axes of rotation, and further comprising simultaneously pressing against opposite sides of the metal plate with the feed rollers.

20. The method of using an automated construction system comprising:
providing an automated construction system, the automated construction system including:
a carousel, the carousel comprising a plurality of radial forming assemblies, the radial forming assemblies comprising rollers and being oriented in an array;
an outer work station, the outer work station residing at about ground level;
an inner work station, the inner work station residing at about ground level;
a shaft, the shaft extending downwardly below ground level from an area residing between the inner work station and the outer work station;
a hoist, the hoist being adapted to raise or lower in the shaft;
feeding metal plate into the array;
bending the metal plate by pushing against a metal plate surface with one or more of the rollers;
simultaneously pressing at least two of the plurality of radial forming assemblies against the metal plate surface; and
forming the metal plate into a first cylindrical structure;
placing the cylindrical structure on the hoist;
lowering the cylindrical structure into the shaft;
placing a second cylindrical structure immediately proximate the first cylindrical structure; and
welding the second cylindrical structure to the first cylindrical structure.
